(19) United States
(12) Patent Application Publication
(10) Pub. No.: US 2026/0304499 A1
(43) Pub. Date: Oct. 1, 2026

(54) DEVICE AND METHOD FOR ACCESSING CHANNEL

(71) Applicant: FRONTSIDE LLC, Seoul (KR)

(72) Inventor: Jeong Soo LEE, Gyeonggi-do (KR)

(21) Appl. No.: 18/998,205

(22) PCT Filed: Jul. 26, 2023
(86) PCT No.: PCT/KR2023/010838

§ 371 Date: Jan. 24, 2025

(30) Foreign Application Priority Data
Jul. 28, 2022 (KR) 10-2022-0093696
Mar. 23, 2023 (KR) 10-2023-0037914

(51) Int. Cl. H04W 74/0833; H04W 74/08; H04W 84/12

(52) U.S. Cl. CPC H04W 74/085; H04W 74/0866; H04W 84/12

(57) ABSTRACT

A device for accessing channel in a wireless local area network is provided. The device monitors simultaneously a first primary channel and a second primary channel. When a network allocation vector (NAV) of the first primary channel is set but the second primary channel is idle, the device switches from the first primary channel to the second primary channel for initiating physical layer protocol data unit (PPDU) transmission on the second primary channel.

### TECHNICAL FIELD

The present disclosure relates to a wireless local area network (WLAN), and more particularly, to channel access mechanism in the WLAN.

### BACKGROUND ART

A wireless local area network (WLAN) may be formed by one or more access points (APs) that provide a shared wireless communication medium for use by a number of client devices also referred to as stations (STAs).

Orthogonal frequency division multiple access (OFDMA) is a multiple access scheme where different subsets of subcarriers are allocated to different users, and this scheme allows simultaneous data transmission to or from one or more users.

A physical layer protocol data unit (PPDU) is a data unit (or data packet) to carry various information in the WLAN. In OFDMA, users are allocated different subsets of subcarriers that can change from one PPDU to the next. Using OFDMA, an AP may allocate different RUs for STAs. The AP can simultaneously transmit various formats of PPDUs to multiple STAs.

### DISCLOSURE OF INVENTION

### Technical Problem

The present disclosure provides a method for accessing a channel in a wireless local area network.

The present disclosure further provides a device for accessing a channel in a wireless local area network.

### Solution to Problem

In an aspect, a method for accessing channel in a wireless local area network is provided. The method performed by a station includes receiving a frame including information on a first primary channel and a second primary channel, monitoring simultaneously the first primary channel and the second primary channel, and, when a network allocation vector (NAV) of the first primary channel is set but the second primary channel is idle, switching from the first primary channel to the second primary channel for initiating physical layer protocol data unit (PPDU) transmission on the second primary channel.

In another aspect, a device for accessing channel in a wireless local area network is provided. The device includes a processor, and a memory operatively coupled with the processor and configured to store instructions that, when executed by the processor, cause the device to perform functions. The functions includes receiving a frame including information on a first primary channel and a second primary channel, monitoring simultaneously the first primary channel and the second primary channel, and, when a network allocation vector (NAV) of the first primary channel is set but the second primary channel is idle, switching from the first primary channel to the second primary channel for initiating physical layer protocol data unit (PPDU) transmission on the second primary channel.

### Advantageous Effects of Invention

As new WLAN communication protocols enable enhanced features, non-primary channel access mechanism is provided to support signaling regarding features and resource allocations.

### BRIEF DESCRIPTION OF DRAWINGS

FIG. 1 shows a block diagram of an example wireless communication network.

FIG. 2 shows a block diagram of an example wireless communication device.

FIGS. 3 and 4 show various examples of PPDUs usable for wireless communication between an AP and a number of STAs.

FIG. 5 shows an example of wireless channel that includes multiple subchannels.

FIG. 6 shows an example of PPDU transmission.

FIG. 7 shows an example of UL MU transmission.

FIG. 8 shows a non-primary channel access mechanism according to an embodiment of the present invention.

FIG. 9 shows an example of SERVICE field to support non-primary channel access mechanism.

FIG. 10. shows a non-primary channel access mechanism according to an embodiment of the present invention.

FIG. 11 shows a non-primary channel access mechanism according to another embodiment of the present invention.

FIG. 12 shows a non-primary channel access mechanism according to still another embodiment of the present invention.

FIG. 13 shows a non-primary channel access mechanism according to still another embodiment of the present invention.

FIG. 14 shows a non-primary channel access mechanism according to still another embodiment of the present invention.

FIG. 15 shows a non-primary channel access mechanism applied to peer-to-peer application according to an embodiment of the present invention.

### MODE FOR THE INVENTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

OFDMA is an OFDM-based multiple access scheme where different subsets of sub-carriers are allocated to different users, and this scheme allows simultaneous data transmission to or from one or more users. In OFDMA, users are allocated different subsets of subcarriers that can change from one PPDU to the next. Similar to OFDM, OFDMA employs multiple subcarriers, but the subcarriers are divided into several groups where each group is referred to as a resource unit (RU).

A physical layer protocol data unit (PPDU) may span one or more subchannels and may include a preamble portion and a data portion. Signaling refers to control fields or information in the preamble portion that can be used by a wireless communication device to interpret another field or portion of the preamble portion or the data portion of the PPDU. A wireless channel may be formed from multiple subchannels. A subchannel may include a set of subcarriers. Portions of the wireless channel bandwidth can be divided or grouped to form different resource units (RUs). An RU may be a unit for resource allocation and may include one or more subcarriers. Among other things, a preamble portion of a PPDU may include signaling to indicate which RUs are allocated to different devices. Other types of signaling include indicators regarding which subchannels include further signaling or which subchannels may be punctured. There are several formats of PPDUs (and related structures) defined for current wireless communication protocols. As new wireless communication protocols enable enhanced features, new preamble designs are needed support signaling regarding features and resource allocations. Furthermore, it desirable to define a new preamble signaling protocol that can support future wireless communication protocols.

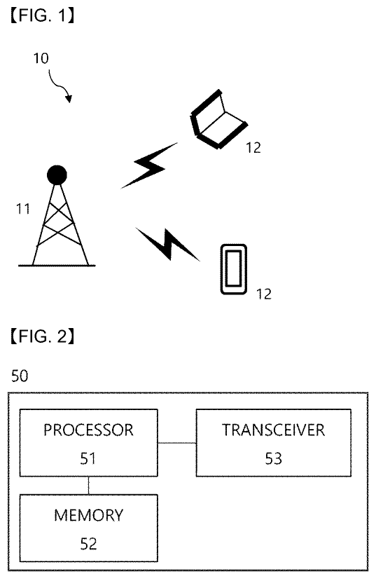

FIG. 1 shows a block diagram of an example wireless communication network.

According to some aspects, the wireless communication network 10 can be an example of a wireless local area network (WLAN) such as a Wi-Fi network (and will hereinafter be referred to as WLAN 10). For example, the WLAN 10 can be a network implementing at least one of the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). The WLAN 10 may include numerous wireless communication devices such as an access point (AP) 11 and multiple stations (STAs) 12. While only one AP 11 is shown, the WLAN network 10 also can include multiple APs.

Each of the STAs 12 also may be referred to as a mobile station (MS), a mobile device, a mobile handset, a wireless handset, an access terminal (AT), a user equipment (UE), a subscriber station (SS), or a subscriber unit, among other possibilities. The STAs 12 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 11 and an associated set of STAs 12 may be referred to as a basic service set (BSS), which is managed by the respective AP 11. The BSS may be identified to users by a service set identifier (SSID), as well as to other devices by a basic service set identifier (BSSID), which may be a medium access control (MAC) address of the AP 11. The AP 11 periodically broadcasts beacon frames (“beacons”) including the BSSID to enable any STAs 12 within wireless range of the AP 11 to “associate” or re-associate with the AP 11 to establish a respective communication link (hereinafter also referred to as a “Wi-Fi link”), or to maintain a communication link, with the AP 11. For example, the beacons can include an identification of a primary channel used by the respective AP 11 as well as a timing synchronization function for establishing or maintaining timing synchronization with the AP 11. The AP 11 may provide access to external networks to various STAs 12 in the WLAN via respective communication link.

To establish a communication link with an AP 11, each of the STAs 12 is configured to perform passive or active scanning operations (“scans”) on frequency channels in one or more frequency bands (for example, the 2.4 GHz, 5 GHz, 6 GHz or 60 GHz bands). To perform passive scanning, a STA 12 listens for beacons, which are transmitted by respective APs 11 at a periodic time interval referred to as the target beacon transmission time (TBTT) (measured in time units (TUs) where one TU may be equal to 1024 microseconds (μs)). To perform active scanning, a STA 12 generates and sequentially transmits probe requests on each channel to be scanned and listens for probe responses from APs 11. Each STA 12 may be configured to identify or select an AP 11 with which to associate based on the scanning information obtained through the passive or active scans, and to perform authentication and association operations to establish a communication link with the selected AP 11. The AP 11 assigns an association identifier (AID) to the STA 12 at the culmination of the association operations, which the AP 11 uses to track the STA 104.

In some cases, STAs 12 may form networks without APs 11 or other equipment other than the STA. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 10. In such implementations, while the STAs 12 may be capable of communicating with each other through the AP 11 using communication links, STAs 12 also can communicate directly with each other via direct wireless links. Additionally, two STAs 12 may communicate via a direct communication link regardless of whether both STAs 12 are associated with and served by the same AP 11. In such an ad hoc system, one or more of the STAs 12 may assume the role filled by the AP 11 in a BSS. Such a STA may be referred to as a group owner (GO) and may coordinate transmissions within the ad hoc network.

The AP 11 and STAs 12 may function and communicate (via the respective communication links) according to the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). These standards define the WLAN radio and baseband protocols for the PHY and medium access control (MAC) layers. The AP 11 and STAs 12 transmit and receive wireless communications (hereinafter also referred to as “Wi-Fi communications”) to and from one another in the form of PPDUs. The AP 11 and STAs 12 in the WLAN 10 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the AP 11 and STAs 12 described herein also may communicate in other frequency bands, such as the 6 GHz band, which may support both licensed and unlicensed communications. The AP 11 and STAs 12 also can be configured to communicate over other frequency bands such as shared licensed frequency bands, where multiple operators may have a license to operate in the same or overlapping frequency band or bands.

Each of the frequency bands may include multiple channels (which may be used as subchannels of a larger bandwidth channel). For example, PPDUs conforming to the IEEE 802.11n, 802.11ac and 802.11ax standard may be transmitted over the 2.4 and 5 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels (which may be referred to as subchannels).

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a first portion (or “legacy preamble”) and a second portion (or “non-legacy preamble”). The first portion may be used for packet detection, automatic gain control and channel estimation, among other uses. The first portion also may generally be used to maintain compatibility with legacy devices as well as non-legacy devices. The format of, coding of, and information provided in the second portion of the preamble is based on the particular IEEE 802.11 protocol to be used to transmit the payload.

Uplink (UL) means that the signal (or message or PPDU) is transmitted by a STA to an AP, and downlink (DL) means that the signal (or message or PPDU) is transmitted by the AP to one or more STAs.

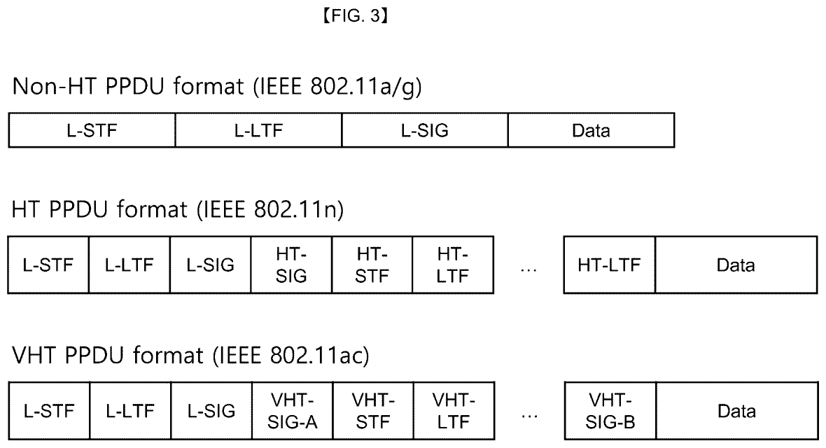

FIG. 2 shows a block diagram of an example wireless communication device.

In some implementations, the wireless communication device 50 can be an example of a device for use in a STA such as one of the STAs 12 described above with reference to FIG. 1. In some implementations, the wireless communication device 50 can be an example of a device for use in an AP such as the AP 11 described above with reference to FIG. 1. The wireless communication device 50 is capable of transmitting (or outputting for transmission) and receiving wireless communications (for example, in the form of wireless packets). For example, the wireless communication device can be configured to transmit and receive packets in the form of PPDUs and/or medium access control (MAC) protocol data units (MPDUs) conforming to an IEEE 802.11 wireless communication protocol standard, such as that defined by the IEEE 802.11-2016 specification or amendments thereof including, but not limited to, 802.11ah, 802.11ad, 802.11ay, 802.11ax, 802.11az, 802.11ba and 802.11be.

The wireless communication device 800 can be, or can include, a chip, system on chip (SoC), chipset, package or device that includes one or more processor 51. The processor 51 can include an intelligent hardware block or device such as, for example, a processing core, a processing block, a central processing unit (CPU), a micro-processor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 51 processes information received through a transceiver 53, and processes information to be output through the transceiver 53 through the wireless medium. For example, the processor 806 may implement a physical (PHY) layer and/or a MAC layer configured to perform various operations related to the generation and transmission of PPDUs, MPDUs, frames or packets.

A memory 52 can include tangible storage media such as random-access memory (RAM) or read-only memory (ROM), or combinations thereof. The memory 808 also can store non-transitory processor-or computer-executable software code containing instructions that, when executed by the processor 51, cause the wireless communication device 50 to perform various operations described herein for wireless communication, including the generation, transmission, reception and interpretation of PPDUs, MPDUs, frames or packets. For example, various functions of components disclosed herein, or various blocks or steps of a method, operation, process or algorithm disclosed herein, can be implemented as one or more modules of one or more computer programs.

The transceiver 53 generally includes at least one radio frequency (RF) transmitter (or “transmitter chain”) for transmitting radio signals and at least one RF receiver (or “receiver chain”) for receiving radio signals. For example, the RF transmitters and receivers may include various DSP circuitry including at least one power amplifier (PA) and at least one low-noise amplifier (LNA), respectively. The RF transmitters and receivers may, in turn, be coupled to one or more antennas. For example, in some implementations, the wireless communication device 50 can include, or be coupled with, multiple transmit antennas (each with a corresponding transmit chain) and multiple receive antennas (each with a corresponding receive chain).

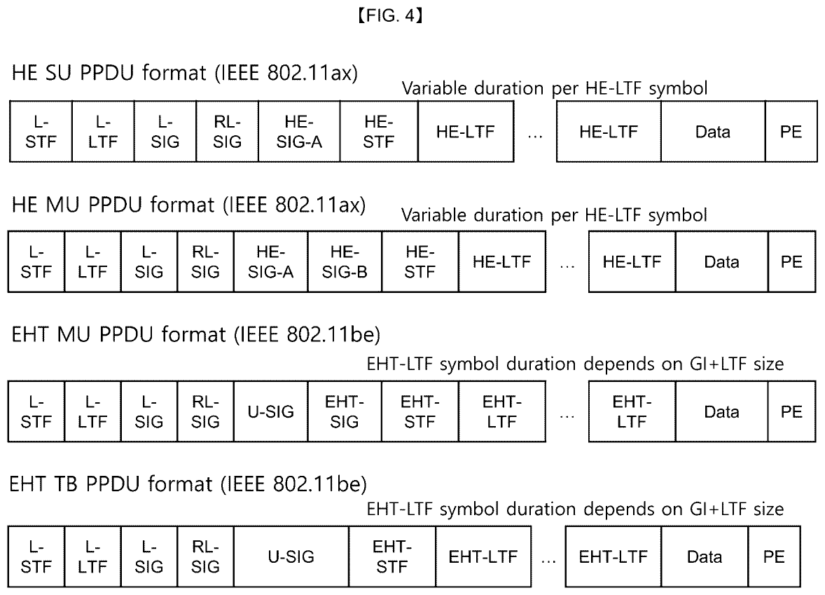

FIGS. 3 and 4 show various examples of PPDUs usable for wireless communication between an AP and a number of STAs.

An PPDU may include a preamble portion and a data portion. ‘Data’ of FIGS. 3-4 denotes the data portion which includes one or more PSDUs and appears after the preamble portion. The data portion may be referred to as a payload.

A non-high-throughput (non-HT) PPDU supporting IEEE 802.11a/g includes a Legacy-Short Training Field (L-STF), a Legacy-Long Training Field (L-LTF), a Legacy-Signal (L-SIG) and a data portion. L-SIG may be called as non-HT Signal. A high-throughput (HT) PPDU supporting IEEE 802.11n includes an L-STF, a HT-SIG, a HT-STF, a HT-LTF and a data portion. A very high throughput (VHT) PPDU supporting IEEE 802.11ac includes an L-STF, L-SIG, a VHT-SIG-A, a VHT-STF, a VHT-LTF, a VHT-SIG-B and a data portion.

A high-efficiency (HE) PPDU supporting IEEE 802.11ax may include an HE single-user (SU) PPDU for SU transmission and an HE multi-user (MU) PPDU for MU transmission. An extremely high throughput (EHT) PPDU supporting IEEE 802.11be may include an EHT MU PPDU for MU transmission and an EHT trigger based (TB) PPDU.

The preamble portion of a PPDU may include a first portion (or “legacy preamble”) and a second portion (or “non-legacy preamble”). The first portion may include L-STF, L-LTF and L-SIG. The second portion may include at least one of HT-SIG, HT-STF, HT-LTF, VHT-SIG-A, VHT-STF, VHT-LTF, VHT-SIG-B, RL-SIG, HE-SIG-A, HE-STF, HE-LTF, HE-SIG-B, EHT-SIG, EHT-STF, EHT-LTF and U-SIG.

The L-STF may be used for frame detection, Automatic Gain Control (AGC), diversity detection, and coarse frequency/time synchronization. The L-LTF may be used for fine frequency/time synchronization and channel estimation. The L-SIG may include information indicating a total length of a corresponding PPDU (or information indicating a transmission time of a PSDU).

The VHT-SIG-A field carries information required to interpret VHT PPDUs. The VHT-STF field is used to improve automatic gain control estimation in a MIMO. The VHT-LTF field provides a means for the receiver to estimate the MIMO channel between the set of constellation mapper outputs and the receive chains. The VHT-SIG-B field may be used for MU transmissions and may contain as signaling information usable by the STAs to decode data received in the DATA field, including, for example, a modulation and coding scheme (MCS) and beamforming information.

The repeated legacy (RL)-SIG field in the HE PPDU and EHT PPDU is a repeat of the L-SIG field and is used to differentiate the HE PPDU and the EHT PPDU from non-HT PPDU, HT PPDU, and VHT PPDU.

HE-SIG-A carries information necessary to interpret HE PPDUs. HE-SIG-A may indicate locations and lengths of HE-SIG-Bs, available channel bandwidths, etc. HE-SIG-B may carry STA-specific scheduling information such as, for example, per-user MCS values and per-user RU allocation information. In the context of DL MU-OFDMA, such information enables the respective STA to identify and decode corresponding RUs in the associated data field.

VHT-STF, HE-STF or EHT-STF may be used to improve an AGC estimation in a MIMO transmission. VHT-LTF, HE-LTF or EHT-LTF may be used to estimate a MIMO channel.

The universal signal field (U-SIG) field of EHT PPDU carries information necessary to interpret EHT PPDUs. The U-SIG may include version independent fields and version dependent fields. The version independent fields may include at least one of a version identifier, a PPDU bandwidth, an indication of whether the PPDU is a UL or a DL PPDU, a BSS color identifying a BSS, and a transmission opportunity (TXOP).

The PPDU bandwidth in the version independent fields indicates a transmission bandwidth of the PPDU, for example, 20 MHz, 40 MHz, 80 MHz, 160 MHz or 320 MHz. The version identifier in the version independent fields may indicate a version (and associated format) for the version dependent fields. A PPDU format may determine which other indicators are included in the version dependent fields as well as the version identifier. In some implementations, if the PPDU format indicates that the PPDU is an EHT TB PPDU, then the EHT-SIG may be omitted as shown in EHT TB PPDU of FIG. 4. The version dependent fields of U-SIG may include punctured channel Information and EHT-SIG MCS. The EHT-SIG MCS may Indicate an MCS used for modulating the EHT-SIG. The PPDU bandwidth and the punctured channel information may be referred to collectively as frequency occupation indications. The frequency occupation indications may permit WLAN devices on the wireless channel to determine the utilization of the various parts of the wireless channel. For example, the frequency occupation information may be used to indicate puncturing of some sub-channels.

The EHT-SIG field provides additional signaling to the U-SIG field for STAs to interpret an EHT MU PPDU. The EHT-SIG may carry STA-specific scheduling information such as, for example, per-user MCS values and per-user RU allocation information. EHT-SIG includes a common field and at least one STA-specific field (“user specific field”). The common field can indicate RU distributions to multiple STAs, indicate the RU assignments in the frequency domain, indicate which RUs are allocated for MU-MIMO transmissions and which RUs correspond to MU-OFDMA transmissions, and the number of users in allocations. The user specific fields are assigned to particular STAs 104 and may be used to schedule specific RUs and to indicate the scheduling to other WLAN devices.

The EHT-SIG field of a 20 MHz EHT MU PPDU contains one EHT-SIG content channel. For OFDMA transmission and for non-OFDMA transmission to multiple users, the EHT-SIG field of an EHT MU PPDU that is 40 MHz or 80 MHz contains two EHT-SIG content channels. For OFDMA transmission and for non-OFDMA transmission to multiple users, the EHT-SIG field of an MU PPDU that is 160 MHz or wider contains two EHT-SIG content channels per 80 MHz. The EHT-SIG content channels per 80 MHz are allowed to carry different information when EHT MU PPDU bandwidth for OFDMA transmission is wider than 80 MHz. The EHT-SIG field of an EHT MU PPDU sent to a single user and the EHT-SIG field of an EHT sounding NDP contains one EHT-SIG content channel and it is duplicated in each non-punctured 20 MHz when the EHT PPDU is equal to or wider than 40 MHz

For OFDMA transmission, the Common field of an EHT-SIG content channel contains information regarding the resource unit allocation such as the RU assignment to be used in the EHT modulated fields of the PPDU, the RUs allocated for MU-MIMO and the number of users in MU-MIMO allocations. In non-OFDMA transmission, the Common field of the EHT-SIG content channel does not contain the RU allocation.

The User Specific fields in the EHT-SIG content channels contains information for all users in the PPDU on how to decode their payload.

A device receiving an PPDU may initially begin or continue its determination of the wireless communication protocol version used to transmit the PPD based on the presence of RL-SIG and the modulation scheme used to modulate the symbols in U-SIG (or HE-SIG-A). In some implementations, the receiving device may initially determine that the wireless communication protocol used to transmit the PPDU is an HE or later version based on the presence of RL-SIG (that is, a determination that the first symbol of the second portion of the preamble is identical to L-SIG) and a determination that both the first symbol and the second symbol following RL-SIG are modulated according to a BPSK modulation scheme.

The techniques in this description are not limited to PPDU formats shown in FIGS. 3-4, but the concepts may apply to any PPDU conforming to IEEE 802.11 wireless communication protocol version.

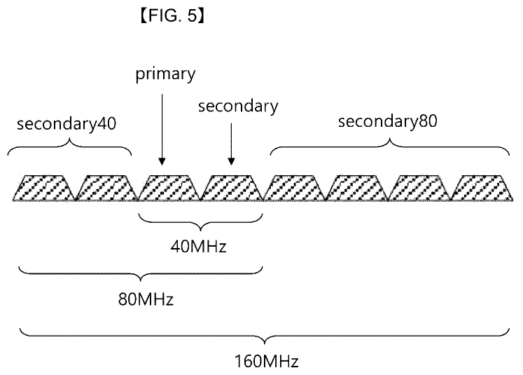

FIG. 5 shows an example of wireless channel that includes multiple subchannels.

A channel map for a frequency band (such as the 2.5 GHz, 5 GHz, 6 GHz frequency band, etc.) may define multiple subchannels. Each subchannel may have a uniform channel width W=20 MHz, but the techniques in this description are not limited to 20 MHz. The channel width W may be smaller than or larger than 20 MHz.

Some WLAN devices are capable of transmitting at higher bandwidths using a wireless channel that is made up of multiple subchannels. When WLAN devices is capable of transmitting at BSS operating channel width is 80 MHz, a group of four subchannels (a primary 20 MHz channel, a secondary 20 MHz channel and a secondary 40 MHz channel) are used. In FIG. 5, BSS operating channel has a bandwidth of 20 MHz, 40 MHz, 80 MHz and 160 MHz. Although depicted as contiguous subchannels in the channel map, in some implementations, the BSS operating channel may contain one or more subchannel which are not adjacent in the channel map. Additionally, larger groups of channels may be used in some implementations. For example, operating channel has a bandwidth of 320 MHz, 640-MHz or larger. The 320 MHz bandwidth may be divided into sixteen 20 MHz subchannels.

The primary channel is the common channel of operation for all STAs that are members of the BSS. The secondary channel is a channel associated with the primary channel used to create a channel wider than the primary channel.

In 40 MHz BSS, the 20 MHz secondary channel adjacent to the primary 20 MHz channel that together form the 40 MHz channel of the 40 MHz BSS.

In 80 MHz BSS, the secondary 20 MHz channel adjacent to the primary 20 MHz channel that together form the primary 40 MHz channel of the 80 MHz BSS. The secondary 40 MHz channel adjacent to the primary 40 MHz channel that together form the 80 MHz channel of the 80 MHz VHT BSS.

In 160 MHz or 80+80 MHz BSS, the secondary 80 MHz channel not including the primary 20 MHz channel, that together with the primary 80 MHz channel including the primary 20 MHz channel form the 160 MHz or 80+80 MHz channel of the 160 MHz or 80+80 MHz BSS.

In 320 MHz BSS, the secondary 160 MHz channel not including the primary 20 MHz channel, which together with the primary 160 MHz channel including the primary 20 MHz channel form the 320 MHz channel of the 320 MHz BSS.

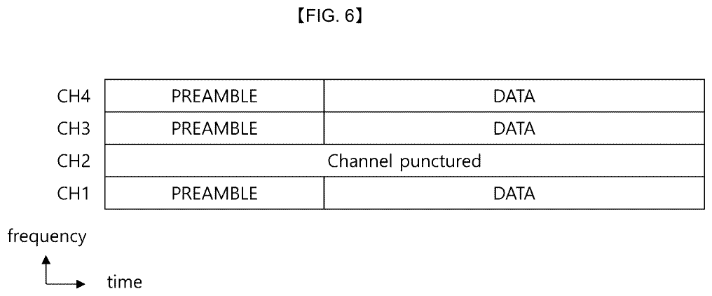

FIG. 6 shows an example of PPDU transmission.

A WLAN device transmits a PPDU by using a four subchannels CH1, CH2, CH3 and CH4 of 80 MHz operating channel. The PPDU may have any PDDU format shown in FIGS. 3-4. A preamble and data in the PPDU may be duplicated every 20 MHz subchannel. Or only a part of the preamble in the PPDU may be duplicated every 20 MHz subchannel.

The WLAN device would perform a clear channel assessment (CCA) before sending a non-triggered transmission. The CCA is a type of collision avoidance technique. Other types may be referred to as carrier sense, carrier detect, listen-before-talk. CCA is performed by a WLAN device to determine if the wireless communication medium (such as the group of subchannels) is available or busy (by another transmission). If the wireless communication medium is in use, the WLAN device may postpone the transmission until the CCA is performed again and the wireless communication medium is idle by another device.

There may be an incumbent system transmission that occupies part of the second subchannel CH2. Therefore, the wireless channel may be punctured to exclude the second subchannel CH2 from the transmission. Thus, the PPDU is sent only on the first subchannel CH1, the third subchannel CH3 and the fourth subchannel CH4.

The punctured channel information may be indicated in a signal field (for example, HE-SIG-A, U-SIG, or EHT-SIG). The punctured channel information may indicate which channels in the total bandwidth (such as 160 MHz or 320 MHz) are punctured, as well as the puncturing mode, such that the receiving STA knows which channels to process for information and which channels are punctured and thus not available or otherwise not including information for processing by the STA.

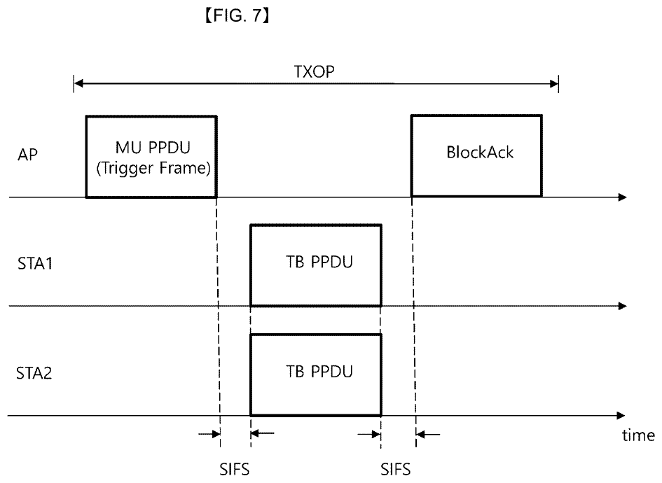

FIG. 7 shows an example of UL MU transmission.

UL MU operation allows an AP to solicit simultaneous immediate response frames from one or more STAs.

The AP may send a trigger frame to one or more STAs (for example, STA1 and STA2). The trigger frame may be sent as MU PPDU (for example, HE MU PPDU or EHT MU PPDU). The STA1 and STA2 may send response PDUs (for example, HE TB PPDU or EHT TB PPDU) in response to the trigger frame. The interframe space between a PPDU that contains a triggering frame and the TB PPDU is a Short Interframe Space (SIFS). The AP sends an Ack or BlockAck frame acknowledging the one ore more TB PPDUs to the response STAs (for example, STA1 and STA2).

The trigger frame allocates resources for and solicits one or more PPDU transmissions. The trigger frame also carries other information required by the responding STA to send a TB PPDU or a non-HT PPDU. The trigger frame may be sent as various types such as a basic trigger frame, Multi-user Request-to Send (MU-RTS) frame, MU-BAR, Beamforming Report Poll (BFRP) Trigger frame, etc.

The trigger frame may include a UL bandwidth field, an channel sensing (CS) required field, one or more STA IDs and one or more RU Allocation field. The UL bandwidth field indicates the bandwidth of the response PPDU. The CS required field indicate whether the response STAs are required to use energy detection (ED) to sense the medium and to consider the medium state and the network allocation vector (NAV) in determining whether or not to respond. The one or more STA IDs identifies the one or more response STAs. The RU Allocation subfield indicates RU allocation for the response PPDU.

A WLAN device classify a received PPDU as an inter-PPDU if (i) the received PPDU is transmitted by an AP which is not associated with the WLAN device, (ii) the received PPDU's BSS is not the BSS of the WLAN device, or (iii) the received PPDU is a downlink MU PPDU and the WLAN device is an AP.

A WLAN device classify a received PPDU as an intra-PPDU if (i) the received PPDU is transmitted by an AP which is associated with the WLAN device, (ii) the received PPDU's BSS is the BSS of the WLAN device, or (iii) the received PPDU is a downlink MU PPDU and the WLAN device is an AP.

An inter-BSS PPDU may be a PPDU that is received by a receiving STA and is transmitted an AP (and/or BSS) which is not associated with the receiving STA. An intra-BSS PPDU may be a PPDU that is received by a receiving STA and is transmitted an AP (and/or BSS) which is associated with the receiving STA.

A STA may classify a received PPDU as an inter-BSS PPDU if at least one of the following conditions is true:
The RXVECTOR parameter BSS_COLOR is not 0 and is not the BSS color of the BSS of which the STA is a member.
The PPDU is a VHT PPDU with RXVECTOR parameter PARTIAL_AID not equal to the BSSID[39:47] of the BSS in which the STA is associated or any of the other BSSs in the same multiple BSSID set or co-hosted BSSID set to which its BSS belongs and the RXVECTOR parameter GROUP_ID is 0.
The PPDU is a VHT PPDU with RXVECTOR parameter PARTIAL_AID[5:8] not equal to the 4 LSBs of the BSS color announced by the BSS of which the STA whose dot11PartialBSSColorImplemented is equal to true is a member and RXVECTOR parameter GROUP_ID equal to 63 when the Partial BSS Color field in the most recent HE Operation element is 1.
The PPDU is either a VHT MU PPDU or an HE MU PPDU with the RXVECTOR parameter UPLINK_FLAG equal to 0, and the STA is an AP.
The PPDU carries a frame that has a BSSID field, the value of which is not the BSSID of the BSS in which the STA is associated or any of the other BSSs in the same multiple BSSID set or co-hosted BSSID set to which its BSS belongs or the wildcard BSSID.
The PPDU carries a frame that does not have a BSSID field but has both an RA field and TA field, neither value of which is equal to the BSSID of the BSS in which the STA is associated or any of the other BSSs in the same multiple BSSID set or co-hosted BSSID set to which its BSS belongs. The Individual/Group bit in the TA field value is forced to 0 prior to comparison.

A STA may classify the received PPDU as an intra-BSS PPDU if at least one of the following conditions is true:
The RXVECTOR parameter BSS_COLOR of the PPDU carrying the frame is the BSS color of the BSS of which the STA is a member or the BSS color of any TDLS links to which the STA belongs if the STA is an HE STA associated with a non-HE AP.
The PPDU is a VHT PPDU with RXVECTOR parameter PARTIAL_AID equal to the BSSID[39:47] of the BSS in which the STA is associated or any of the other BSSs in the same multiple BSSID set or co-hosted BSSID set to which its BSS belongs and the RXVECTOR parameter GROUP_ID equal to 0.
The PPDU is a VHT PPDU with RXVECTOR parameter PARTIAL_AID[5:8] equal to the 4 LSBs of the BSS color announced by of the BSS of which the STA whose dot11PartialBSSColorImplemented is equal to true is a member, the RXVECTOR parameter GROUP_ID is equal to 63, and the Partial BSS Color field in the most recent HE Operation element is 1.
The PPDU carries a frame that has an RA, TA, or BSSID field value that is equal to the BSSID of the BSS or the BSSID of any BSS in which the STA is associated or any of the other BSSs in the same multiple BSSID set or co-hosted BSSID set to which its BSS belongs. The Individual/Group bit in the TA field value is forced to the value 0 prior to the comparison.
The PPDU carries a Control frame that does not have a TA field and that has an RA field value that matches the saved TXOP holder address of the BSS or any BSS in which the STA is associated or any of the other BSSs in the same multiple BSSID set or co-hosted BSSID set to which its BSS belongs.

NAV is an indicator, maintained by each STA, of time periods when transmission onto the wireless medium (WM) is not initiated by the STA regardless of whether the STA's clear channel assessment (CCA) function senses that the WM is busy. While a NAV counter is not zero (or NAV indicates busy), the STA can not access the channel. When a STA receives a PPDU which is not transmitted by the STA or is not destined to the STA, the STA can update NAV (or set/reset NAV counter).

A ‘back-off procedure’ is a channel sending (CS) procedure to confirm that a wireless medium (or a channel) is idle. A STA desiring to initiate transfer of Data frames and/or Management frames needs to invoke the CS mechanism to determine the busy/idle state of the medium. If the medium is busy, the STA defers until the medium is determined to be idle without interruption for a period of time equal to a first interval (for example, extended interframe space (EIFS)) when the last transition to idle medium was a result of a frame detected on the medium that was not received correctly, or equal to a second interval (for example, DCF interframe space (DIFS)) otherwise. After this DIFS or EIFS medium idle time, the, the STA shall then generate a random backoff count for an additional deferral time before transmitting, unless the back-off counter already contains a non-zero value, in which case the selection of a random number is not needed and not performed. This process minimizes collisions during contention between multiple STAs that have been deferring to the same event.

Hereinafter, Non-Primary Channel Access Mechanism is described.

When a WLAN device receives an inter-BSS PPDU on a primary channel (for example, primary 20/40/80/160/320/640 MHz channel), the WLAN device sets a NAV counter of the primary channel and records the occupied primary channel set.

In the conventional IEEE 802.11 protocol, the WLAN device cannot access the entire operating channel when the primary channel is not idle regardless of whether any secondary channel is idle or not. An TXOP is obtained based solely on activity of a primary channel. Therefore, when the primary channel is busy, the STA cannot access the channel and cannot initiate any transmission.

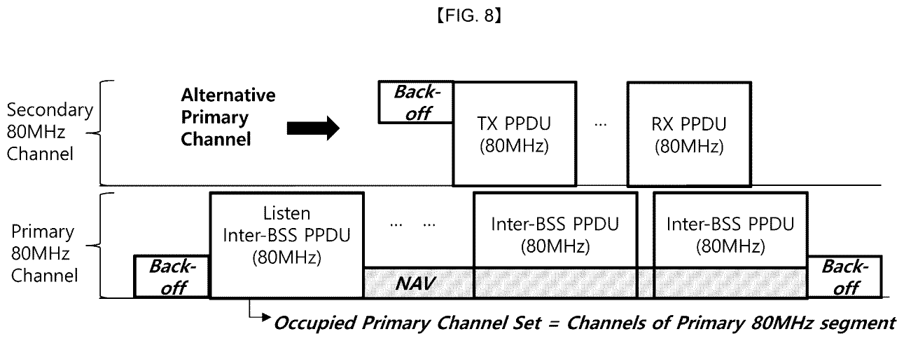

FIG. 8 shows a non-primary channel access mechanism according to an embodiment of the present invention.

An AP may announce the primary channel and/or alternative primary channel to STAs. A STA can receive a frame (for example, beacon frame) including information on at least one of the primary channel and the alternative primary channel. The frame may further information on at least one secondary channel associated with the alternative primary channel. The primary channel may not overlap with the alternative primary channel in frequency domain. The primary channel is used for the baseline channel access (e.g., EDCA) for all kinds of STAs (e.g., 802.11a/b/g/n/ac/ax/be). The alternative primary channel is used for the non-primary channel access mechanism according to the embodiments described in this specification.

The alternative primary channel may be referred to as various terms such as additional primary channel, selected primary channel, etc. When the primary channel is called as the first primary channel, the alternative primary channel is called as the second primary channel.

The alternative primary channel may be located in the non-primary channels. The alternative primary channel may be located in the secondary channels associated with the primary channel. The bandwidth of the alternative primary channel may be one of 20 MHz, 40 MHz, 80 MHz, 160 Mhz and 320 MHz. The primary channel and alternative primary channel should be located in different frequency segments (for example, different 80 MHz segments) or in difference frequency bands.

While a NAV counter of the primary channel is set from an inter-BSS PPDU, a STA may invoke a new back-off procedure on the alternative primary channel unless the alternative primary channel is a subset of the occupied primary channel set. If the NAV counter of the primary channel is expired, the back-off procedure of the alternative primary channel is stopped (i.e., the back-off counter of the alternative primary channel is reset). If the back-off counter of the alternative primary channel is expired but the NAV counter of the primary channel is not expired, the STA can initiate a TXOP on the alternative primary channel. In which case the duration of that TXOP may not exceed the current NAV counter of the primary channel. The TXOP can use other idle non-primary channels.

Based on receiving an inter-BSS PPDU, the STA can switch from the primary channel to the alternative primary channel. Based on receiving an inter-BSS PPDU, the STA can monitor the alternative primary channel. ‘Monitor a channel’ means that the STA performs CS on the channel to check whether the channel is idle for initiating PPDU transmission and/or means that the STA listens the channel for receiving a PPDU on the channel. The STA can check the idleness of the alternative primary channel regardless of receiving any PPDU on the primary channel.

After the STA moves to the alternative primary channel, the STA can switch back to the primary channel before the NAV counter of the primary channel is expired. The STA can switch back to the primary channel when the NAV counter of the primary channel is expired.

According the non-primary channel access mechanism, a STA can temporarily switch to the alternative primary channel for PPDU transmission or PPDU reception while the primary channel is not available.

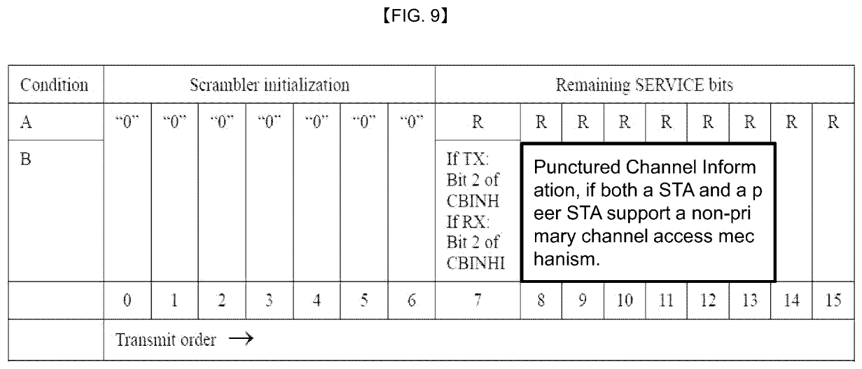

FIG. 9 shows an example of SERVICE field to support non-primary channel access mechanism.

A data field in an PPDU carrying (MU-)RTS frame may include the SERVICE field, the PSDU and the padding bits.

When a STA initiates a TXOP on the alternative primary channel, the STA may first exchange (MU-)RTS/CTS frames with the AP. An (MU-)RTS frame includes information that the STA obtains a TXOP from accessing the alternative primary channel. For example, an (MU-)RTS frame includes the punctured channel information in the SERVICE field, where the punctured channel information indicates that the primary channel is punctured but the alternative primary channel is not punctured.

While a NAV counter of the primary channel is set from an inter-BSS PPDU, a STA may receive an (MU-)RTS frame on the alternative primary channel from a peer STA supporting a non-primary channel access mechanism. If the received (MU-)RTS frame indicates that the peer STA obtained a TXOP from accessing the alternative primary channel (e.g., the punctured channel information in the SERVICE field indicates that the primary channel is punctured but the alternative primary channel is not punctured) and the CS of that alternative primary channel is idle, the STA may send the CTS frame on that alternative primary channel. Otherwise, the STA does not send the CTS frame. While a NAV counter of the primary channel is not set from an inter-BSS PPDU (including the CS of the primary channel is idle), a STA may not send the CTS frame even if the STA receives an (MU-)RTS frame on the alternative primary channel from a peer STA supporting a non-primary channel access mechanism.

After a moving STA moves to the alternative primary channel, the moving STA can transmit a RTS frame on the alternative primary channel to a receiving STA. The RTS frame includes information on the alternative primary channel and/or an indication indicating that the moving STA moves to the alternative primary channel. The receiving STA can send a CTS frame when the receiving STA also moves to the alternative primary channel. The receiving STA may not send a CTS frame when the receiving STA does not move to the alternative primary channel. If the receiving STA does not support the alternative primary channel, the receiving STA may not send a CTS frame.

After a STA moves to the alternative primary channel, the STA may not send a CTS frame in response to a RTS frame which is received on the primary channel.

When a STA that received an RTS frame on the alternative primary channel sends the CTS frame, the CTS frame may indicate the channels that cannot be used because of an adjacent channel interference (ACI) or alternative adjacent channel interference (AACI) (which is caused from the PPDUs transmitted by other STA on the primary channel). For example, a CTS frame includes the punctured channel information in the SERVICE field, where the punctured channel information indicates channel(s) that cannot be used because of a performance degradation caused by an ACI or AACI.

Since the CTS frame transmitted in a response of the MU-RTS frame has the same content, in order to report the punctured channel information specific to each STA, an AP may transmit a Punctured Channel Report Poll (PCRP)-Trigger frame.

After receiving the PCRP-Trigger frame, the STA reports the punctured channel information in the Punctured Channel Report (PCR) Control subfield in the A-Control field in the QoS Null/Data/Management frame sent in the TB PPDU. The PCR Control subfield may have 6 bits information. Punctured channel information can be encoded as RU unit rather than a 20 MHz channel unit.

Instead of puncturing the channel(s) that are impacted from an ACI or AACI, an AP may transmit an Interference Channel Report Poll (ICRP)-Trigger frame. After receiving the ICRP-Trigger frame, the STA reports the interference channel information in the Interference Channel Report (ICR) Control subfield in the A-Control field in the QoS Null/Data/Management frame sent in the TB PPDU. Interference channel information is represented by the channel number that are impacted from an ACI or AACI, the interference strength on the corresponding channel, the recommended MCS on the corresponding channel. Interference channel information can be encoded as RU unit rather than a 20 MHz channel unit.

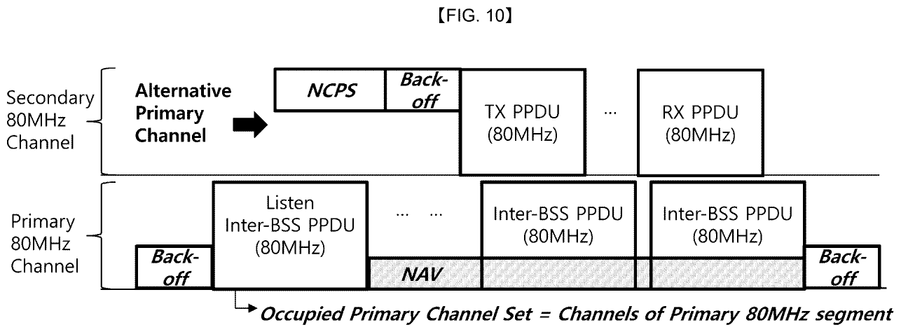

FIG. 10. shows a non-primary channel access mechanism according to an embodiment of the present invention. Compared with the embodiment shown in FIG. 8, monitoring can simultaneously be performed on the primary channel and the alternative primary channel.

While a NAV counter of the primary channel is set from an inter-BSS PPDU, a STA may invoke a back-off procedure after sensing a wireless medium on the alternative primary channel during a Non-Primary CS (NPCS) timer unless the alternative primary channel is a subset of the occupied primary channel set. If the NAV counter of the primary channel is expired, the back-off procedure of the alternative primary channel is stopped (i.e., the back-off counter of the alternative primary channel is reset).

While a NAV counter of the primary channel is set from an inter-BSS PPDU, a STA senses a wireless medium on the alternative primary channel during the Non-Primary CS (NPCS) timer. If the CS status of the wireless medium is identified as an idle or busy during the NPCS timer, the STA invoke a new back-off procedure.

While a NAV counter of the primary channel is set from an inter-BSS PPDU, the STA may invoke a new back-off procedure if the wireless medium is idle during the NPCS timer. While a NAV of the primary channel is set, the STA may invoke a back-off procedure on the alternative primary channel if the alternative primary channel is idle while the NPCS timer is running.

The NPCS timer may represent an interval to monitor the alternative primary channel. The NPCS timer may represent an interval to monitor the alternative primary channel before invoking a back-off procedure on the alternative primary channel. The NPCS timer may represent an interval to monitor the alternative primary channel before switching to the alternative primary channel.

The NPCS timer may be referred to as a NPCS interval. The AP can send information on the value of the NCPS timer or the NPCS interval. The NPCS interval may be greater than any interframe space (IFS). The NPCS interval may be given integer multiple of an IFS. While monitoring during the NPCS interval, no random back-off counter is generated. While monitoring the alternative primary channel during the NPCS interval, the alternative primary channel may be detected as idle when the alternative primary channel remains idle during the NPCS interval.

A STA can simultaneously monitor the primary channel and the alternative primary channel. The STA may invoke a back-off procedure immediately on the primary channel. The STA may invoke a back-off procedure on the alternative primary channel after the STA confirms that the alternative primary channel is idle during the NPCS timer.

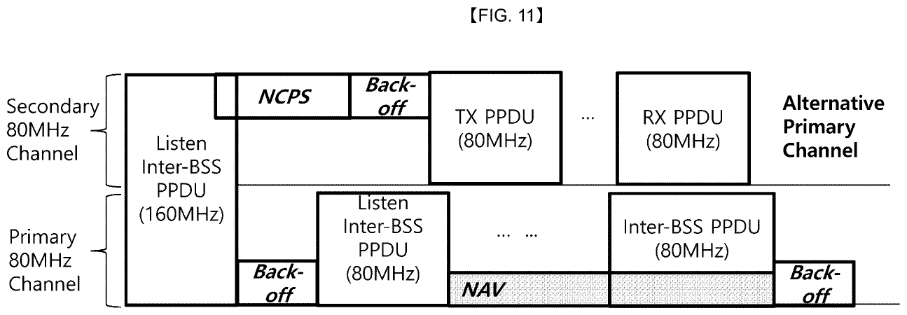

FIG. 11 shows a non-primary channel access mechanism according to another embodiment of the present invention.

While a NAV counter of the primary channel is set from an inter-BSS PPDU, the occupied time is considered as a part of the NPCS timer even though the wireless medium is not idle if the alternative primary channel is occupied by an inter-BSS PPDU. So, the STA can invoke a new back-off procedure after the NPCS timer.

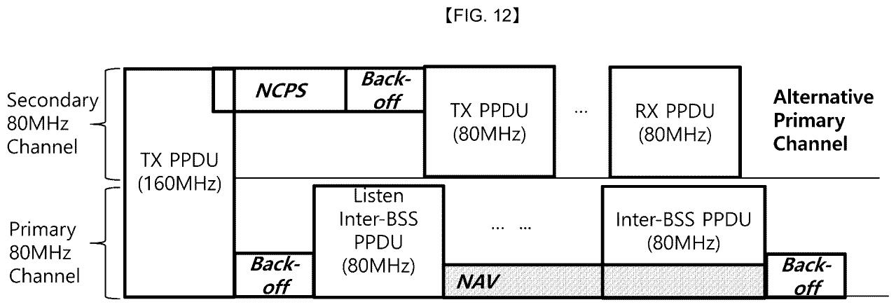

FIG. 12 shows a non-primary channel access mechanism according to still another embodiment of the present invention.

While a NAV counter of the primary channel is set from an inter-BSS PPDU, the occupied time is considered as a part of the NPCS timer even though the wireless medium is not idle if the alternative primary channel is occupied by an intra-BSS PPDU. So, the STA can invoke a new back-off procedure after the NPCS timer.

When the alternative primary channel is occupied by a PPDU (for example, inter-BSS PPDU and/or intra-BSS PPDU), the STA regards that the alternative primary channel is idle during a part of the NPCS timer overlapped with the duration of the occupied PPDU. When the alternative primary channel is occupied by a specific STA (a STA which is not associated with the STA's AP and/or a STA which is associated with the STA's AP), the STA regards that the alternative primary channel is idle during a part of the NPCS timer overlapped with the occupied duration of the specific STA.

When the alternative primary channel is occupied by a PPDU (for example, inter-BSS PPDU and/or intra-BSS PPDU), the STA may ignore the alternative primary channel's CCA results during the duration of the PPDU. When the alternative primary channel is occupied by a PPDU (for example, inter-BSS PPDU and/or intra-BSS PPDU), the STA may not monitor the alternative primary channel during the duration of the PPDU. The NPCS interval may be reduced by an amount of overlapped interval with the duration of the occupied PPDU.

While a NAV counter of the primary channel is set from an inter-BSS PPDU, if the back-off counter of the alternative primary channel is expired but the NAV counter of the primary channel is not expired, the STA can initiate a TXOP on the alternative primary channel. In which case the duration of that TXOP does not exceed the current NAV counter of the primary channel. The TXOP can use other idle non-primary channels.

When a STA initiates a TXOP on the alternative primary channel, the STA first exchanges (MU-)RTS/CTS frames. An (MU-)RTS frame includes a bandwidth information on which the STA obtains a TXOP from accessing the alternative primary channel. A STA that is addressed by an RTS frame in a non-HT or non-HT duplicate PPDU that has a bandwidth signaling TA and that has the RXVECTOR parameter DYN BANDWIDTH_IN_NON_HT equal to Static behaves as follows:
(i) If the NAV indicates idle and CCA has been idle for all secondary channels (secondary 20 MHz channel, secondary 40 MHz channel, and secondary 80 MHz channel) in the channel width indicated by the RTS frame's RXVECTOR parameter CH_BANDWIDTH_IN_NON_HT for a PIFS prior to the start of the RTS frame, then the STA shall respond with a CTS frame carried in a non-HT or non-HT duplicate PPDU after a SIFS. The CTS frame's TXVECTOR parameters CH_BANDWIDTH and CH_BANDWIDTH_IN_NON_HT shall be set to the same value as the RTS frame's RXVECTOR parameter CH_BANDWIDTH_IN_NON_HT.
(ii) Otherwise, the STA shall not respond with a CTS frame.

A STA that is addressed by an RTS frame in a non-HT or non-HT duplicate PPDU that has a bandwidth signaling TA and that has the RXVECTOR parameter DYN_BANDWIDTH_IN_NON_HT equal to Dynamic behaves as follows:
(i) If the NAV indicates idle, then the STA shall respond with a CTS frame in a non-HT or non-HT duplicate PPDU after a SIFS. The CT frame's TXVECTOR parameters CH_BANDWIDTH and CH_BANDWIDTH_IN_NON_HT shall be set to any channel width for which CCA on all secondary channels has been idle for a PIFS prior to the start of the RTS frame and that is less than or equal to the channel width indicated in the RTS frame's RXVECTOR parameter CH_BANDWIDTH_IN_NON_HT.
(ii) Otherwise, the STA shall not respond with a CTS frame.

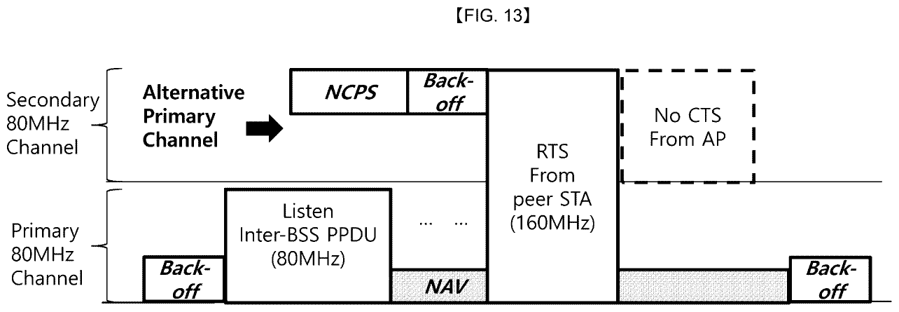

FIG. 13 shows a non-primary channel access mechanism according to still another embodiment of the present invention.

When a STA listening on the alternative primary channel receives an (MU-)RTS frame on the alternative primary channel from a peer STA supporting a non-primary channel access mechanism, if the bandwidth information indicated in the received (MU-)RTS frame includes the primary channel, the STA shall not respond with a CTS frame. This is happened because the peer STA obtains a TXOP by accessing the primary channel. Or, alternative option is that the STA responds with a CTS frame on the alternative primary channel excluding the primary channel. Then, the peer STA initiate frame exchanges on the alternative primary channel.

The AP receives an inter-BSS PPDU and sets the NAV. The AP switches to the alternative primary channel which is located on the secondary 80 MHz segment. After identifying that the wireless medium is idle during the NPCS timer, the AP invokes a new backoff procedure on the alternative primary channel.

While performing the backoff procedure, the AP receives the RTS frame whose bandwidth signaling information is equal to 160 MHz. Since 160 MHz channel covers the primary channel, the AP does not send the CTS response. Probably, the peer STA sent 160 MHz RTS after obtaining a TXOP on the primary channel. The hidden node problem causes this unsynchronized status between the AP and STA.

When a STA listening on the alternative primary channel receives an (MU-)RTS frame on the alternative primary channel from a peer STA supporting a non-primary channel access mechanism, if the Duration information indicated in the received (MU-)RTS frame exceeds the NAV counter of the primary channel of the STA, the STA may not respond with a CTS frame, or responds with a CTS frame having the reduced Duration information. The reduced Duration information is a value less than or equal to the NAV counter of the primary channel of the STA. This can be happened because two STAs receive different inter-BSS PPDUs on the primary channel.

When a STA supporting the non-primary channel access mechanism has another association/connection with an overlapping basic service set (OBSS), the STA should provide the related OBSS information (e.g., BSSID and BSS Color).

In such case, the peer STA that obtains a TXOP using a non-primary channel access mechanism should not initiate a frame exchange to the STA if the inter-BSS PPDU that triggered the non-primary channel mechanism is sent from the OBSS provided by the STA.

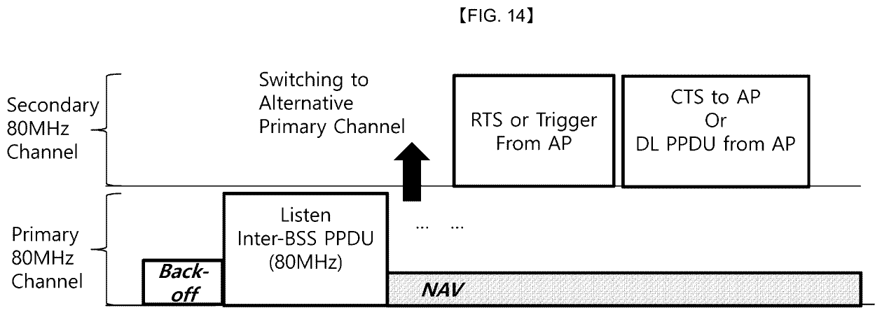

FIG. 14 shows a non-primary channel access mechanism according to still another embodiment of the present invention.

After a STA switches to the alternative primary channel, the STA can monitor the alternative primary channel for PPDU reception. Before/After the STA switches to the alternative primary channel, the STA can send to an AP an indication that the STA switches to the alternative primary channel.

When the STA receives a RTS frame from the AP on the alternative primary channel, the STA can send a CTS frame on the alternative primary channel as a response to the RTS frame. When the STA receives a trigger frame from the AP on the alternative primary channel, the STA can receive a DL PPDU according to an allocation in the trigger frame.

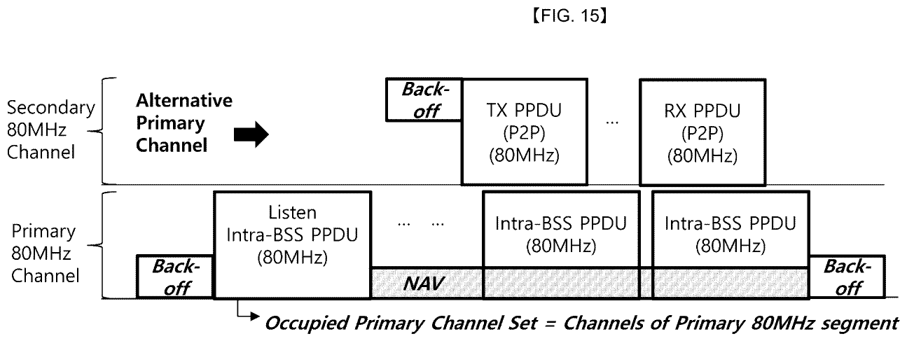

FIG. 15 shows a non-primary channel access mechanism applied to peer-to-peer application according to an embodiment of the present invention.

The non-primary channel access mechanism can be extended to a peer-to-peer (P2P) application. When a P2P STA receives an intra-BSS PPDU addressed to its associated AP on a primary channel (for example, a primary 20/40/80/160/320/640 MHz channel), the P2P STA sets a NAV counter of the primary channel and records the occupied primary channel set.

While a NAV counter of the primary channel is set from the intra-BSS PPDU addressed to its associated AP, a STA may invoke a new back-off procedure after sensing a wireless medium on the alternative primary channel during a NPCS timer unless the alternative primary channel is a subset of the occupied primary channel set. If the NAV counter of the primary channel is expired, the back-off procedure of the alternative primary channel is stopped (i.e., the back-off counter of the alternative primary channel is reset).

If the back-off counter of the alternative primary channel is expired but the NAV counter of the primary channel is not expired, the STA can initiate a TXOP on the alternative primary channel to peer P2P STA. In which case the duration of that TXOP does not exceed the current NAV counter of the primary channel. The TXOP can use other idle non-primary channels.

As used herein, a phrase referring to “at least one of” or “one or more of” a list of items refers to any combination of those item, including single members. For example, “at least one of: a, b, and c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

While operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1-12. (canceled)

13. A method for accessing channel in a wireless local area network, the method performed by a station which is a member of a first basic service set (BSS) and comprising:
receiving a beacon frame including information on a first primary channel and a second primary channel, the first primary channel being a common channel of operation for all stations that are members of the first basic service set (BSS);
receiving an inter-BSS physical layer protocol data unit (PPDU) on the first primary channel, the inter-BSS PPDU being transmitted by a transmitting station which is a member of a second BSS;
if channels occupied by the inter-BSS PPDU does not overlap with the second primary channel, switching from the first primary channel to the second primary channel so that the station is ready to transmit and receive frames on the second primary channel; and
initiating a transmission opportunity (TXOP) on the second primary channel by performing a backoff on the second primary channel.

14. The method of claim 13, wherein the second primary channel is a secondary channel selected among a plurality of secondary channels associated with the first primary channel in the first BSS.

15. The method of claim 13, wherein initiating the TXOP on the second primary channel includes:
transmitting a trigger frame for soliciting one or more PPDU transmissions on the second primary channel, the trigger frame including information on the trigger frame being transmitted on the second primary channel.

16. The method of claim 15, wherein channels occupied by the trigger frame are within an operating bandwidth of the first BSS and does not include any of channels occupied by the inter-BSS PPDU.

17. The method of claim 16, wherein the operating bandwidth of the first BSS is 160 MHz or 320 MHz, and the operating bandwidth of the first BSS includes at least two 80 MHz channels.

18. The method of claim 17, wherein the first primary channel and the second primary channel are located in different 80 MHz channels among the at least two 80 MHz channels.

19. A device for accessing channel in a wireless local area network, the device which is a member of a first basic service set (BSS) and comprising:
a processor; and
a memory operatively coupled with the processor and configured to store instructions that, when executed by the processor, cause the device to perform functions comprising:
receiving a beacon frame including information on a first primary channel and a second primary channel, the first primary channel being a common channel of operation for all stations that are members of the first basic service set (BSS);
receiving an inter-BSS physical layer protocol data unit (PPDU) on the first primary channel, the inter-BSS PPDU being transmitted by a transmitting station which is a member of a second BSS;
if channels occupied by the inter-BSS PPDU does not overlap with the second primary channel, switching from the first primary channel to the second primary channel so that the device is ready to transmit and receive frames on the second primary channel; and
initiating a transmission opportunity (TXOP) on the second primary channel by performing a backoff on the second primary channel.

20. The device of claim 19, wherein the second primary channel is a secondary channel selected among a plurality of secondary channels associated with the first primary channel in the first BSS.

21. The device of claim 19, wherein initiating the TXOP on the second primary channel includes:
transmitting a trigger frame for soliciting one or more PPDU transmissions on the second primary channel, the trigger frame including information on the trigger frame being transmitted on the second primary channel.

22. The device of claim 21, wherein channels occupied by the trigger frame are within an operating bandwidth of the first BSS and does not include any of channels occupied by the inter-BSS PPDU.

23. The device of claim 22, wherein the operating bandwidth of the first BSS is 160 MHz or 320 MHz, and the operating bandwidth of the first BSS includes at least two 80 MHz channels.

24. The device of claim 23, wherein the first primary channel and the second primary channel are located in different 80 MHz channels among the at least two 80 MHz channels.
